(19) United States
(12) Patent Application Publication
(10) Pub. No.: US 2016/0309775 A1
(43) Pub. Date: Oct. 27, 2016

(54) NATURALLY EXTRACTED TOBACCO E-LIQUIDS AND SYSTEMS AND METHODS FOR PRODUCING THE SAME

(71) Applicant: Chase Franklin Parker, Tampa, FL (US)

(72) Inventor: Chase Franklin Parker, Tampa, FL (US)

(21) Appl. No.: 15/133,942

(22) Filed: Apr. 20, 2016

Related U.S. Application Data
(60) Provisional application No. 62/151,099, filed on Apr. 22, 2015.

(51) Int. Cl. A24B 15/26; A24B 15/16; B01D 11/02; A24B 15/24

(52) U.S. Cl. CPC A24B 15/26; A24B 15/24; A24B 15/16; B01D 11/0288; B01D 11/0292

(57) ABSTRACT

Improved Naturally Extracted Tobacco (NET) E-liquids that are substantially free of sugars and suitable for use with any E-cigarette, and systems and methods for producing the same, according to various embodiments, are described herein.

### RELATED APPLICATIONS

This application claims the benefit of, and priority to, U.S. Provisional Application No. 62/151,099, filed on Apr. 22, 2015, which is incorporated herein by reference in its entirety.

### BACKGROUND

Electronic cigarette (E-cigarette) users are constantly searching for a tobacco flavored E-liquid that does not taste artificial. Although currently a small market, Naturally Extracted Tobacco (NET) E-liquids are gaining in popularity quickly. Many E-cigarette users love the natural flavor of NET E-liquids; however, existing NET E-liquids have a major flaw. Existing NET E-liquids clog the heating apparatus in E-cigarettes quickly due to the natural sugars from the tobacco leaf crystallizing on the heating coil. Currently coils range from $3 to $6, which makes E-cigarettes more costly than a pack of traditional cigarettes, leading some users to revert back to their old habit. Improved NET E-liquids, which do not adversely affect the E-cigarettes with which they are used or components thereof, are needed.

### SUMMARY

The present invention provides, in various embodiments, improved Naturally Extracted Tobacco E-liquids that are sugar-free (substantially free of the natural sugars found in tobacco leaves), and systems and methods for producing the same. The present invention advantageously extracts the desirable aromatic compounds from natural tobacco while also removing the unwanted sugars. The resulting NET E-liquids are intended to be compatible with any type of E-cigarette apparatus. NET E-liquids of the present invention deliver the satisfaction of natural tobacco while also saving the end user from the frustration and cost of replacing heating coils frequently.

In some embodiments, the invention provides a method for producing a sugar-free Naturally Extracted Tobacco E-liquid, comprising: macerating natural tobacco leaves in a first solution comprising a first solvent and a second solvent; straining the macerated solution to remove leaf particles; and removing the first solvent from the strained solution to yield a mixture comprising the second solvent, tobacco waxes, and tobacco oils. The method further comprises: filtering said mixture to separate the tobacco waxes from the second solvent and the tobacco oils; separating the tobacco oils from the second solvent; and combining the tobacco waxes and the tobacco oils in a carrier liquid to form the NET E-liquid.

In some embodiments, the method further comprises combining nicotine and/or one or more flavorings with the tobacco waxes and the tobacco oils in the carrier liquid to form the NET E-liquid.

In some embodiments, the first solvent comprises ethanol.

In some embodiments, the second solvent comprises water. In some embodiments, the second solvent comprises at least one of propylene glycol and vegetable glycerin.

In some embodiments, said straining comprises straining the macerated solution through a filter having a pore size of about 5 μm to remove the leaf particles.

In some embodiments, said removing comprises removing the first solvent from the macerated solution by vacuum distillation with heat.

In some embodiments, said filtering comprises filtering said mixture through a filter having a pore size of about 2 μm or less to separate the tobacco waxes from the second solvent and the tobacco oils.

In some embodiments, said separating comprises separating the tobacco oils from the second solvent using a separatory funnel.

In some embodiments, said combining comprises combining the tobacco waxes and the tobacco oils in at least one of propylene glycol and vegetable glycerin. In some embodiments, said combining comprises combining the tobacco waxes and the tobacco oils in polyethylene glycol.

In some embodiments, the method further comprises adding a third solvent to at least a portion of the filtered tobacco waxes to yield a second mixture; heating the second mixture to extract additional tobacco oils from the tobacco waxes; separating the additional tobacco oils from the third solvent; and combining the tobacco waxes, the tobacco oils, and the additional tobacco oils in a carrier liquid to form the NET E-liquid.

In some embodiments, the third solvent comprises water.

In some embodiments, the invention provides a sugar-free Naturally Extracted Tobacco E-liquid produced according to the above-described method. In some embodiments, the sugar-free Naturally Extracted Tobacco E-liquid further comprises added nicotine and/or flavorings. In some embodiments, the sugar-free Naturally Extracted Tobacco E-liquid comprises a carrier liquid consisting essentially of a combination of propylene glycol and vegetable glycerin. In some embodiments, the sugar-free Naturally Extracted Tobacco E-liquid comprises a carrier liquid consisting essentially of PEG 400.

Additional features and advantages of the present invention are described further below. This summary section is meant merely to illustrate certain features of the invention, and is not meant to limit the scope of the invention in any way. The failure to discuss a specific feature or embodiment of the invention, or the inclusion of one or more features in this summary section, should not be construed to limit the invention as claimed.

### BRIEF DESCRIPTION OF THE DRAWINGS

The foregoing summary, as well as the following detailed description of the preferred embodiments of the application, will be better understood when read in conjunction with the appended drawings. For the purposes of illustrating the present application, there are shown in the drawings preferred embodiments. It should be understood, however, that the application is not limited to the precise arrangements and instrumentalities shown. In the drawings:

FIG. 1 is a schematic showing an exemplary system and methods of the invention, according to some embodiments.

FIG. 2 is a flowchart showing exemplary methods of the invention, according to some embodiments.

### DETAILED DESCRIPTION

Existing NET E-liquids comprise a combination of natural sugars and aromatic compounds, which when used with an E-cigarette give a realistic sensation of a traditional cigarette. However, over a short period of time the sugars which are dissolved in the E-liquid burn and crystallize onto the heating coil of the E-cigarette, causing loss of vapor and flavor.

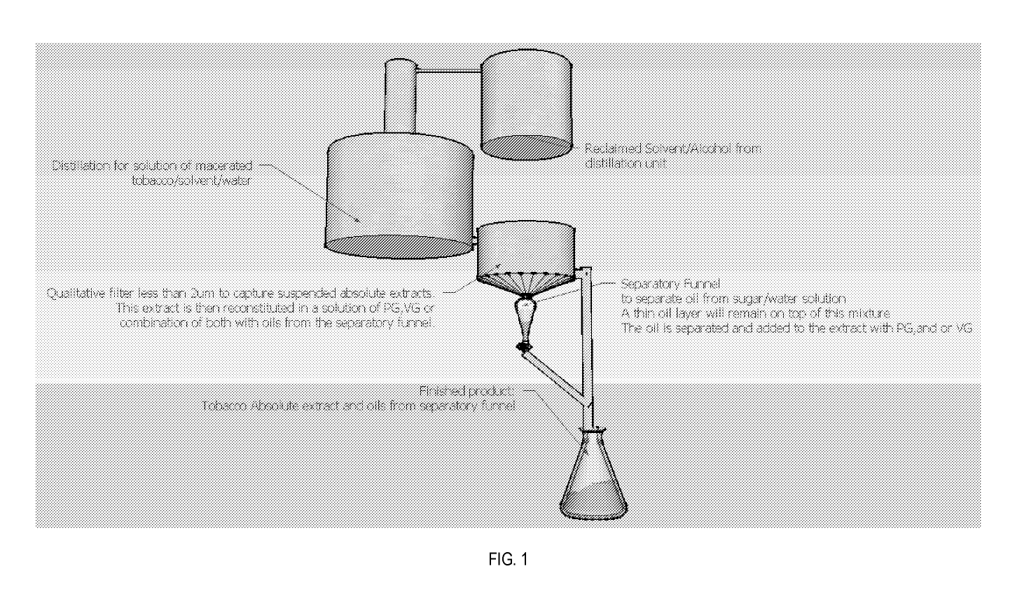

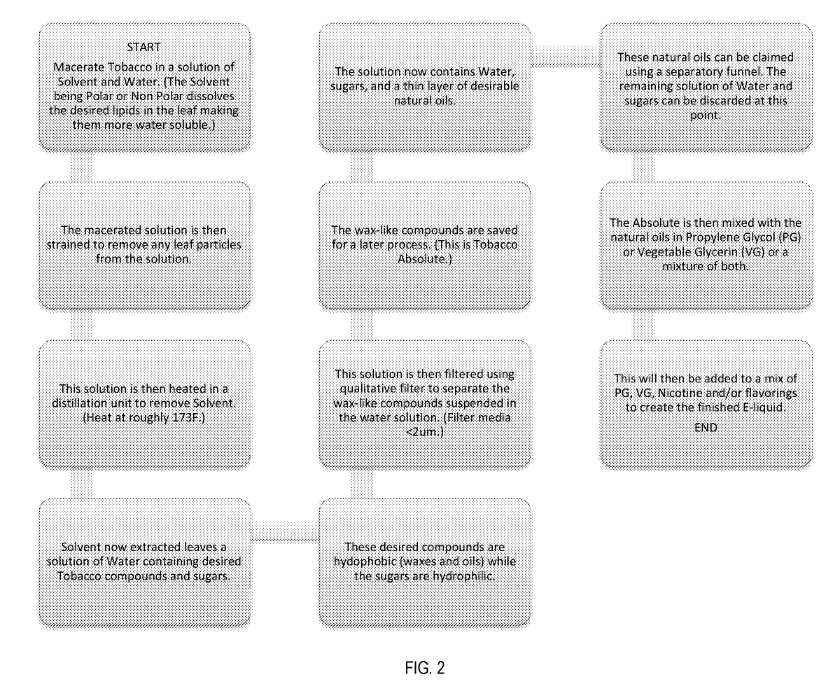

The present invention provides, in various embodiments, systems and methods for producing NET E-liquids that are substantially free of unwanted sugars that can clog the heating apparatus in E-cigarettes. Schematics of exemplary systems and methods of the invention are shown in FIG. 1 and FIG. 2.

In preferred embodiments of the invention, tobacco leaves are macerated in a first solution. The first solution may comprise a first solvent and a second solvent. In some embodiments, the first solvent comprises a polar and/or a non-polar solvent (e.g., ethyl alcohol, hexane, etc.). In certain preferred embodiments, the first solvent comprises ethanol. In some embodiments, the second solvent comprises water and/or water-miscible liquid(s). In some embodiments, the second solvent comprises Propylene Glycol (PG), Vegetable Glycerin (VG), or a combination of the two. In some embodiments, the first solution comprises pure grain alcohol. In some embodiments, the first solution comprises about 76% ethanol and about 24% water. The percentage (v/v) of first solvent to second solvent in the first solution may vary. The percentage (w/v) of tobacco leaves to solution may also vary. Various types of tobacco leaves may be used, according to preference. In some embodiments of the invention, the types of cured tobacco are chosen for properties which would closely represent a real cigarette.

The tobacco and first solution are preferably mixed vigorously (shaken, vortexed, etc.) to dissolve the desired compounds that are in the tobacco leaf. In some embodiments, the mixture may be gently heated to assist the maceration. In some embodiments, the mixture may be left for a period of time (e.g., days, weeks, months). The mixture may be agitated (constantly, at random, or at predetermined intervals), during the soaking time.

The macerated solution is then strained, removing the leaf matter. In some embodiments, the tobacco leaves may be pressed to remove as much liquid as possible. The macerated solution is preferably strained through a filter suitable for removing any of the larger leaf particles (e.g., 5 μm polyester felt material). In some embodiments, the resulting strained liquid is approximately 70 to 95 percent of the volume of the macerated solution.

In preferred embodiments, the first solvent is then removed from the strained liquid. The first solvent may be removed by various means known to those of ordinary skill in the art. In some embodiments, the first solvent is removed by heating the strained solution in a distillation unit until the first solvent is collected (e.g., as shown in FIG. 1). The temperature and time required for the distillation may be determined by those of ordinary skill in the art depending on the type of first solvent that is used. For example, for a solution comprising about 76% ethanol and about 24% water, the liquid may be heated to about 173° F. to remove the first solvent. The first solvent thus extracted is pure and can be reused.

The resulting mixture comprises the second solvent, which has the natural tobacco sugars dissolved therein, and remaining desirable plant matter. With the first solvent removed, the hydrophobic compounds from the tobacco are suspended in the second solvent and will not mix. These compounds are in the form of waxes/resins (sugarless tobacco absolute) and oil. The second solvent may be passed through a qualitative filter (e.g., as shown in FIG. 1) to capture the solid mass of waxes that are suspended therein. Various types of qualitative filters are known in the art and may be used. Preferably, the filter used to separate the waxes has a pore size of about 2 μm or less. In some embodiments, the filter comprises a 0.5 μm polyester felt material.

The sugarless tobacco absolute that is recovered on the filter is saved to be reconstituted in the finished product. The volume of sugarless tobacco absolute may vary (e.g., according to maceration efficiency, variety and/or amount of tobacco leaves, etc.). In some embodiments, the volume of sugarless tobacco absolute is about 0.1%-10% (w/v) of the second solvent.

The filtered second solvent still has dissolved sugar and a small amount of desirable tobacco oil as a top layer. In preferred embodiments, the natural oil is separated from the second solvent. The oil and solvent may be separated by various means known to those of ordinary skill in the art. In some embodiments, the oil is separated using a laboratory separatory funnel (e.g., as shown in FIG. 1). This apparatus is a tear drop shaped funnel with a stopcock at the bottom allowing the user to drain the bottom liquid while retaining the oil that is on top. As indicated in FIG. 2, the remaining solution of second solvent and sugars can be discarded.

In some embodiments, additional oil may be obtained by further refining the sugarless tobacco absolute. For example, the waxes recovered on the filter may be mixed with water or other suitable solvent. The resulting mixture may then be distilled (e.g., by heating at about 187 to 190° F.) to remove the oils from the waxes, resulting in water with a small amount of oil suspended on top. The suspended oil may be isolated (e.g., using a separatory funnel as described above).

Predetermined amounts of sugarless tobacco absolute and natural oils may then be mixed into a carrier liquid. Various suitable carrier liquids may be used, including, but not limited to, Propylene Glycol (PG), Vegetable Glycerin (VG), a combination of PG and VG, and polyethylene glycol (e.g., PEG 400). Other suitable carrier liquids are known to those of ordinary skill in the art and may be used. Various additives may also be included (e.g., nicotine, flavorings, etc.) to create the finished E-liquid. In some embodiments, the finished E-liquid may be filtered one last time (e.g., using filter media having a pore size of 0.5 μm or less), to remove any particles from the final product.

The systems/methods of the present invention solve a large problem in the current E-cigarette market, by removing the sugars in existing NET E-liquids that clog the E-cigarette heating coils. E-smokers can now enjoy the same natural tobacco tastes they have grown accustomed to over the years without the harmful effects of the traditional combustible cigarette, and avoid the costly maintenance of the current NET E-liquids.

While there have been shown and described fundamental novel features of the invention as applied to the preferred and exemplary embodiments thereof, it will be understood that omissions and substitutions and changes in the form and details of the disclosed invention may be made by those skilled in the art without departing from the spirit of the invention. Moreover, as is readily apparent, numerous modifications and changes may readily occur to those skilled in the art. Hence, it is not desired to limit the invention to the exact construction and operation shown and described, or the precise arrangement, structures, features, embodiments, aspects, and devices described herein, and the arrangements, structures, features, embodiments, aspects and devices may be used singularly or in combination with other arrangements, structures, features, embodiments, aspects and devices. Accordingly, all suitable modification equivalents may be resorted to falling within the scope of the invention as claimed. It is the intention, therefore, to be limited only as indicated by the scope of the claims appended hereto.

The following examples are given for purposes of illustration only, and are not intended to be construed in a limiting manner.

### Example 1

In this Example, cured tobacco is chosen for the properties which would most closely represent a Marlboro Red Cigarette. The tobacco leaves used comprise: 2 oz. Flue Cured Virginia Red Leaf, 1 oz. Aged Burley, and 1 oz. Yendji Oriental Leaf. These tobacco leaves are cut into fine strips and placed into a jar which is then filled with about 1500 mL of a solution comprising twenty percent ethyl alcohol to eighty percent water. The tobacco is allowed to soak over a twenty four hour period with occasional agitation of the mixture. The tobacco leaves are then removed from the solution and pressed to remove as much solution as possible. The solution collected is then filtered using 5 micron Polyester Felt material, which removes any of the larger leaf particles. A total of about 1280 mL are collected and placed in a 2000 mL Erlenmeyer flask, with a vacuum distillation unit attached. The temperature with vacuum boils the alcohol steadily at 160 degrees Fahrenheit for 65 minutes total. The distillation removes approximately 250 mL of alcohol. The remaining 1030 mL of liquid are cooled to room temperature, then filtered using 0.5 micron Polyester Felt to separate the suspended waxes. The wax collected has a weight of about 2.6 grams total. The remaining liquid is then placed in a separatory funnel to remove the natural oils. The oils are approximately 2.7 mL total. The wax and oil is then added to 80 mL of Propylene Glycol and filtered of one last time using 0.5 micron filter media or less to remove any particles from the final product.

### Example 2

Table 1 below shows an exemplary composition of a NET E-liquid of the present invention, according to some embodiments. The formulation below is for 10 mL of NET E-liquid having 6 mg Nicotine strength, in a carrier comprising a VG/PG mix.

TABLE 1

| | Volume in mL | Percent v/v |
|---|---|---|
| Propylene Glycol | 2.69 | 26.9 |
| Vegetable Glycerin | 6.0 | 60 |
| 10 mg/mL Nicotine in PG base | 0.6 | 6 |
| Flavorings: | | |
| Marlboro Red Extract | 0.55 | 5.5 |
| Tabanone | 0.025 | 0.25 |
| Dimethylpyrazine | 0.06 | 0.6 |
| Vanillin | 0.075 | 0.75 |

Those skilled in the art will recognize that the present invention has many applications, may be implemented in many manners and, as such is not to be limited by the foregoing embodiments and examples.

Any number of the features of the different embodiments described herein may be combined into one single embodiment, the locations of particular elements can be altered and alternate embodiments having fewer than or more than all of the features herein described are possible. Functionality may also be, in whole or in part, distributed among multiple components, in manners now known or to become known.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention. While there have been shown and described fundamental features of the invention as applied to being exemplary embodiments thereof, it will be understood that omissions and substitutions and changes in the form and details of the disclosed invention may be made by those skilled in the art without departing from the spirit of the invention. Moreover, the scope of the present invention covers conventionally known, future developed variations and modifications to the components described herein as would be understood by those skilled in the art.

What is claimed is:

1. A method for producing a sugar-free Naturally Extracted Tobacco E-liquid, comprising:
macerating natural tobacco leaves in a first solution comprising a first solvent and a second solvent;
straining the macerated solution to remove leaf particles;
removing the first solvent from the strained solution to yield a mixture comprising the second solvent, tobacco waxes, and tobacco oils;
filtering said mixture to separate the tobacco waxes from the second solvent and the tobacco oils;
separating the tobacco oils from the second solvent; and
combining the tobacco waxes and the tobacco oils in a carrier liquid to form the NET E-liquid.

2. The method of claim 1, further comprising combining nicotine with the tobacco waxes and the tobacco oils in the carrier liquid to form the NET E-liquid.

3. The method of claim 1, further comprising combining one or more flavorings with the tobacco waxes and the tobacco oils in the carrier liquid to form the NET E-liquid.

4. The method of claim 1, wherein the first solvent comprises ethanol.

5. The method of claim 1, wherein the second solvent comprises water.

6. The method of claim 1, wherein the second solvent comprises at least one of propylene glycol and vegetable glycerin.

7. The method of claim 1, wherein said straining comprises straining the macerated solution through a filter having a pore size of about 5 μm to remove the leaf particles.

8. The method of claim 1, wherein said removing comprises removing the first solvent from the macerated solution by vacuum distillation with heat.

9. The method of claim 1, wherein said filtering comprises filtering said mixture through a filter having a pore size of about 2 μm or less to separate the tobacco waxes from the second solvent and the tobacco oils.

10. The method of claim 1, wherein said separating comprises separating the tobacco oils from the second solvent using a separatory funnel.

11. The method of claim 1, wherein said combining comprises combining the tobacco waxes and the tobacco oils in at least one of propylene glycol and vegetable glycerin.

12. The method of claim 1, wherein said combining comprises combining the tobacco waxes and the tobacco oils in polyethylene glycol.

13. The method of claim 1, further comprising:
adding a third solvent to at least a portion of the filtered tobacco waxes to yield a second mixture;
heating the second mixture to extract additional tobacco oils from the tobacco waxes;
separating the additional tobacco oils from the third solvent; and
combining the tobacco waxes, the tobacco oils, and the additional tobacco oils in a carrier liquid to form the NET E-liquid.

14. The method of claim 1, wherein the third solvent comprises water.

15. A sugar-free Naturally Extracted Tobacco E-liquid produced according to the method of claim 1.

16. The sugar-free Naturally Extracted Tobacco E-liquid of claim 15, further comprising added nicotine and flavorings.

17. The sugar-free Naturally Extracted Tobacco E-liquid of claim 15, wherein the carrier liquid consists essentially of a combination of propylene glycol and vegetable glycerin.

18. The sugar-free Naturally Extracted Tobacco E-liquid of claim 15, wherein the carrier liquid consists essentially of PEG 400.
